(19) United States
(12) Patent Application Publication
(10) Pub. No.: US 2005/0257143 A1
(43) Pub. Date: Nov. 17, 2005

(54) Printing to displays

(75) Inventor: Simon Charles Roger Lewis, Bristol (GB)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: THE APPLIANCE STUDIO LIMITED, Bristol (GB)

(21) Appl. No.: 10/515,796

(22) PCT Filed: May 14, 2003
(86) PCT No.: PCT/GB03/02078

§ 371 Date: Jul. 15, 2005

(30) Foreign Application Priority Data
May 22, 2002 (GB) 0211802.4

(51) Int. Cl. G06F 17/24; G09G 5/00

(52) U.S. Cl. 715/527; 345/204

(57) ABSTRACT

A display device is arranged to emulate a conventional computer printer, thereby allowing documents and/or images to be displayed in a simple and convenient manner, using conventional printer interconnection techniques and which allows the image or document to be displayed without inclusion of any elements of the graphical user interface provided by the software application that generated the image or document. The display device may also include storage medium for storing one or more images to be subsequently displayed on the display device 12.

### CROSS REFERENCE TO RELATED APPLICATIONS

This application claims priority to International Application No. PCT/GB03/02078 filed on 14 May 2003, that claims the benefit of priority to Application Number 0211802.4 filed 22 May 2002, in the United Kingdom.

### BACKGROUND OF THE INVENTION

The present invention relates generally to the field of information display, and in particular to displaying information on one or more devices used for such display, such as those arranged to communicate with a computer system, a printer, and other communication devices.

Conventional computer displays of all types (CRT, plasma, LCD etc.) use a number of different technologies to facilitate interconnection with the computer. Presently, most common is the VESA VGA standard, although other digital standards including LVDS (Low Voltage Digital Signalling) and serial standards such as USB and IEEE 1394 (Firewire) have been proposed as alternatives.

All these existing display connection mechanisms have two characteristics in common. First, they require a direct point-to-point connection between the display and the computer. This has the disadvantage that the connection is limited in length by the electrical characteristics of the interconnecting cable and this limits the distance from the computer at which the display may be sited (primarily because the computer outputs video signals (for example RGB) having a bandwidth of several MHz). Second, they result in the display device displaying the full user-interface of the computer. That is, taking the example of a conventional photographic imaging system, they display both the photographic image and the graphical user interface that provides access to various features of the imaging system. There is therefore always a compromise to be struck between the area of the display to be devoted to the photographic image versus the area of display to be devoted to the graphical user interface.

Although such interconnection techniques are highly appropriate for the conventional use of personal computers, there are a great number of situations in which these techniques present a significant inconvenience. Such situations include those where the user of a personal computer is attempting to share electronic content with others. An example of this is the use of a computer to present material in a conference room. A common scenario is that the computer located in the conference room will be connected to a large display device, such as a projector display or plasma screen, as a replacement or additional display to the conventional display of the computer. Whilst this works reasonably well for predefined presentations where it is not necessary for the user to access and therefore display any elements of the graphical user interface, as soon as this becomes necessary, for example when an image or document is being created or altered as a result of the combined efforts of the occupants of the conference room, it becomes necessary to display elements of the graphical user interface. Whilst necessary for the individual operating the computer, the display of the graphical user interface elements is of no benefit to the other occupants of the conference room and reduces the size of the actual image or document being displayed.

As an alternative to attempting to display an image or document to a number of people using a large display device, the image or document in question may be printed to generate one or more hard copies of the image or document. This has the advantage that as many copies of the image or document as is necessary for each person can be generated, without the inclusion of elements of the graphical user interface. However, printing is not instantaneous and removes the element of spontaneity in respect of suggesting and making changes to an image or document. Furthermore, where each person has more than one printed document available, there is the potential for confusion over which document is currently being discussed. Even if only one document is printed, people may not be looking at the same page.

On the other hand, delivering documents to a printer does circumvent the physical interconnection difficulties associated with display devices. Different interconnection technologies are used including serial and parallel interfaces, wireless connections, and interconnection over computer networks such as IP LANs, intranets and the internet. This allows documents or images to be printed from a computer to one or more physically distant locations. Furthermore, delivering documents to the printer is currently seen and understood by users as practically and conceptually different to displaying them on an electronic display. Printers use a number of different, and in some cases, competing technologies but all result in the conversion of a digital image or document into ink on paper or some equivalent substrate. Current computer operating systems typically present a user with the capability to convert any electronic document or image into a form that can be sent to a printer. This is typically achieved using one or more printer “drivers.” Typically, a computer will have more than one printer driver installed on it, allowing the user the choice of which printer to send a document or image to.

Nonetheless, it is not presently possible to combine the advantages of a display device, such as the instant availability of an image or document, with the advantages of a printing device, such as interconnection variety and image presentation. As such, there remains a need to combine the advantages of a display device with those of a printing device.

### SUMMARY OF THE INVENTION

The present invention solves many problems and disadvantages associated current display devices.

Generally, and in one form, the present invention provides for a display device for displaying an output document arranged to be in operable communication with a computer system and arranged to emulate a printer, such that, in response to receiving from the computer system transmitted data defining an output document, the transmitted data being generated in response to the operation of a print function provided by a software application being executed by the computer system, the output document is displayed by the display device. The display device comprises a store arranged to store output documents communicated to it and may be arranged to store an index of stored output documents. With the present invention, the display device is typically arranged to display the stored index in response to a user command.

Additionally or alternatively, the display device comprises an input device arranged to allow a user to select one of the stored output documents from the index for display by the display device. The stored index may also be accessible by the computer system, whereby one of the stored output documents is remotely selected for display by the display device. Stored output documents may also be allocated individual URLs and selected using an HTTP compatible browser.

The provision of a store within the display device allows one or more output documents to be stored therein for subsequent display. By use of an index of stored output documents, a desired image may be selected and subsequently displayed without any need for further input from a computer system. As such, the display may operate in a “stand alone” mode. This removes the need for a separate computer to be connected to the display device when displaying the stored output documents. When needed, previously printed and stored documents may be reviewed with greater ease than would be possible by remotely recalling them from the computer system connected to the display device. With remote access to the display device from the computer system, the display device may be remotely operated, for example over an intranet or the internet. When remotely operated, documents or other information content may be shared by more than one participant and at different locations (e.g. different offices, different geographic locations, etc.).

The image store typically comprises a removable storage medium. When removable, output documents that have been displayed and stored, or stored only by the display device may be removed for display on a further display device. A non volatile non-removable store may also be provided in addition to or instead of a removable storage medium.

Typically, the display device includes any one or combination of a liquid crystal display, a plasma screen display, a CRT display and a projector. Other forms of display include printing (e.g., for output, to a display for presentation, etc.). In addition, the display device may include, or may be connectable to, a wireless communication device.

In another form, the present invention provides for a computer system including a display device as described above.

In yet another form, the present invention provides for a method of displaying an output document on a display device, the method comprising communicating from a computer system data defining the output document to be displayed to the display device, the communicated data being generated in response to the operation of a print function provided by a software application being executed by the computer system, and operating the display device in a mode of operation that emulates a printer, whereby the communicated data received by the display device cause the output document to be displayed.

In still another form, the present invention provides for a computer program product comprising a one or more computer code instructions that, when executed by a computer, cause the computer to communicate data defining an output document to a display device, the communicated data being generated in response to the operation of a print function provided by a software application being executed by the computer system, whereby the communicated data cause the output document to be displayed by the device.

Preferably, the computer program product is provided on a computer readable medium.

Among the advantages of the present invention is that it provides a display device that may be conceptually and practically treated as an additional printer. For example, images or documents or other information bearing data to be shared with others may be printed to a display device of the present invention using any of the available printer interconnection mechanisms. In addition, with the present invention, no graphical user interface elements are typically displayed.

Those skilled in the art will further appreciate the above-noted features and advantages of the invention together with other important aspects thereof upon reading the detailed description that follows in conjunction with the drawings.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 depicts a display device according to an aspect of the present invention with a point-to-point connection with a personal computer;

FIG. 2 depicts a display device according to an aspect of the present invention connected to a computer system via a network; and

FIG. 3 depicts a display device incorporating non-volatile storage in accordance with an aspect of the present invention.

### DETAILED DESCRIPTION OF THE INVENTION

Although making and using various embodiments of the present invention are discussed in detail below, it should be appreciated that the present invention provides many inventive concepts that may be embodied in a wide variety of contexts. The specific aspects and embodiments discussed herein are merely illustrative of ways to make and use the invention, and do not limit the scope of the invention.

In the description which follows, like parts may be marked throughout the specification and drawing with the same reference numerals, respectively. The drawing figures are not necessarily to scale and certain features may be shown exaggerated in scale or in somewhat generalized or schematic form in the interest of clarity and conciseness.

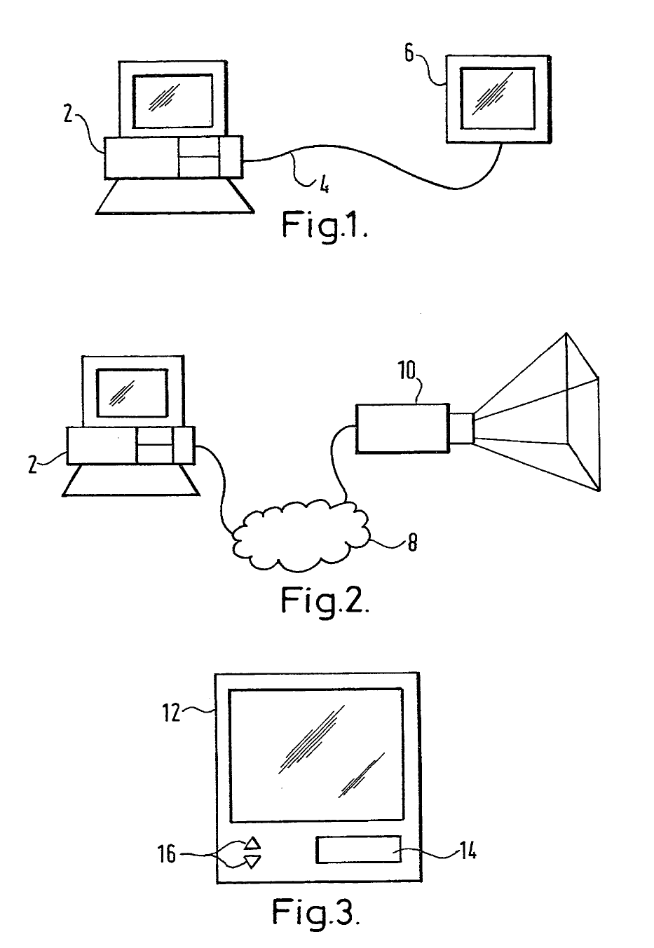

Referring now to FIG. 1, a conventional personal computer 2 is connected via a direct point-to-point connection 4, such as a serial or parallel cable, to a display panel 6. Panel 6 is able to incorporate additional electronic control circuitry and embedded software enabling it to emulate a printer in respect of its communications with personal computer 2. In one embodiment, personal computer 2 has been provided with a software printer driver suitable for the appropriate computer operating system and arranged to drive display panel 6 via interconnecting cable 4. The combination of printer driver software and the control circuitry and software embedded in display panel 6 has the effect of presenting display panel 6 to personal computer 2, and hence to a user, as if it were simply a conventional printer connected to personal computer 2. Therefore, in use, any conventional software application capable of printing to an ordinary printer will be capable of communicating an image or document to display panel 6 simply by use of a conventional print command.

In another embodiment, display panel 6 includes electronics and embedded software that may be configured to mimic the behaviour of an existing conventional printer. With such a configuration, there is not generally a requirement for any further software printer driver to be installed on personal computer 2, especially when a suitable printer driver software is included with the standard computer operating system. In addition, and when needed, it is possible to display an image or document on display panel 6 that is currently being manipulated by a user operating personal computer 2. This may be performed without any elements of the graphical user interface being displayed on display panel 6 and/or visible to a user of personal computer 2. In addition, any required operations for displaying such an image or document on display panel 6 are simply those required for printing the image or document to a printer, which requires no additional learning by the user or operator of personal computer 2.

When display panel 6 is emulating a printer and capable of displaying any static image or document printed to it from personal computer 2, it may also be capable of displaying moving images. As such, with the provision of suitable driver software or embedded electronics, moving images, such as video clips or animations, may also be printed to display panel 6.

FIG. 2 depicts yet another example of the present invention. In FIG. 2, a conventional personal computer 2, as described with reference to FIG. 1, is connected via a network 8 to any display device know to one of ordinary skill, such as projector 10. Network 8 may be any conventional network (e.g., local area network, intranet, internet, wireless network, as examples) and personal computer 2 being equipped with any software printer driver suitable for driving projector 10 across network 8. For FIG. 2, arrangements of personal computer 2 and display device 10 may be the same or similar to that described with reference to FIG. 1.

With the present invention, using a network as the interconnection medium allows a greater variety and flexibility of use of display device 10. For example, it allows display device 10 to be used by any one of a number of suitably configured computers connected to network 8 and may now behave in the same manner as a networked printer. As another example, the addition of a network allows for remote access of display device 10, as may benefit one or more users when in a teleconference or videoconferences.

FIG. 3 schematically illustrates yet another example of the present invention, In FIG. 3, display device 12 includes a non-volatile storage unit 14, for example flash memory or a hard-disk. Storage unit 14 allows display device 12 to receive and store images and documents to be displayed at a subsequent time, in addition to those images and documents capable of immediate display. All images and/or documents are printed to display 12 as previously described. Further, display device 12 is also equipped with a suitable user-interface driven through either the display itself or via an additional display panel (not shown). The user-interface permits the selection of at least one image and/or document from an index of images and/or documents stored on storage unit 14. Stored images and/or documents may then be displayed after selection. FIG. 3 shows how selection of at least one image may be accomplished, in part, using input buttons 16. Where display device 12 is connected to a network, such as that shown in FIG. 2, the network may be used to make available the index of available images and/or documents that have been previously stored on storage unit 14, thereby allowing a remote operator to select as well as display any stored image and/or document. HTML or an equivalent set up may be used with the present invention to access stored images and/or documents. For example, stored images and/or documents may present as a series of web pages, each web page having an individual URL. Such a set up may facilitate the use of a conventional HTTP browser to access and/or index stored images and/or documents.

It is also possible that an image and/or document may be stored on storage unit 14 in response to an image and/or document being displayed on display device 12. The arrangement is such that each time an image and/or document is printed from a suitably equipped computer to display device 12, the image and/or document is stored in storage unit 14 and a new entry made in the image index. Alternatively, the arrangement may provide for images and/or documents to be stored in the storage unit 14 only in response to a user command. The user command may be issued from a computer connected to display device 12 or in response to a suitable input device provided on display unit 12.

When needed, storage unit 14 may be a removable storage medium. This provides the possibility that displayed images may be stored for an indefinite period of time by removing storage unit 14 from display device 12. A second display device (not shown) may also be included in an arrangement, such that images captured using display device 12 or a first display device are subsequently displayed on a second display device. For example, storage unit 14 or any comparable storage medium may be moved from the first display device to the second display device.

Providing a display device of the present invention with its own storage medium allows the display device to be used independent of additional computer systems or connections thereto. As such, one or more required images and/or documents may be stored in advance on storage unit 14 or the like and used at a later time or date on display unit 12, by using a computer system to generate the images and/or documents, printing them to display unit 12, and subsequently retrieving the stored images for later display.

The present invention, therefore, provides a display device and methods of using such a display device that combines the advantages of both conventional displays and conventional printers.

Additional objects, advantages and novel features of the invention as set forth in the description, will be apparent to one skilled in the art after reading the foregoing detailed description or may be learned by practice of the invention. The objects and advantages of the invention may be realized and attained by means of the instruments and combinations particularly pointed out here.

1-14. (canceled)

15. A display device for displaying an output document arranged to be in operable communication with a computer system and arranged to emulate a printer, such that in response to receiving from the computer system transmitted data defining an output document, the transmitted data being generated in response to the operation of a print function provided by a software application being executed by the computer system, the output document is displayed by the display device:

16. The display device of claim 15, wherein the display device further comprises a store arranged to store output documents.

17. The display device of claim 16, wherein the display device is arranged to store an index of stored output documents.

18. The display device of claim 16, wherein the display device further comprises an input device arranged to allow a user to select one or more of the stored output documents from the index for display by the display device.

19. The display device of claim 17, wherein the stored index is accessible by the computer system, whereby one or more of the stored output documents can be remotely selected for display by the display device.

20. The display device of claim 19, wherein said stored output documents are allocated an individual URL and an HTTP compatible browser is provided for said selection.

21. The display device of claim 16, wherein the store comprises a removable storage medium.

22. The display device of claim 15, wherein the display device is selected from the group consisting of Liquid Crystal Display, plasma screen display, CRT display, projector, and combinations thereof.

23. The display device of claim 15, wherein the display device includes or is operably connected to a wireless communication device.

24. A computer system for displaying an output document having the display device of claim 15.

25. A method of displaying an output document on a display device comprising the steps of:
communicating from a computer system data defining the output document to be displayed to the display device, the communicated data being generated in response to the operation of a print function provided by a software application being executed by the computer system; and
operating the display device in a mode of operation that emulates a printer, whereby the communicated data received by the display device cause the output document to be displayed.

26. A computer program product for displaying an output document comprising:
one or more computer code instructions that, when executed by a computer, cause the computer to communicate data defining an output document to a display device, the communicated data being generated in response to the operation of a print function provided by a software application being executed by the computer system, whereby the communicated data cause the output document to be displayed by the device.

27. The computer program product of claim 26, wherein the computer program product is stored on a computer readable medium.

28. A computer readable medium having stored thereon the computer program product of claim 26.

29. The display device of claim 15, wherein the display device is operably connected to a computer system.
